(19) United States
(12) Patent Application Publication
(10) Pub. No.: US 2005/0172061 A1
(43) Pub. Date: Aug. 4, 2005

(54) Device controller

(76) Inventor: Shinji Ushigami, Kanagawa (JP)

Correspondence Address: Theodore D Lienesch;Thompson Hine & Flory, 2000 Courthouse Plaza NE, PO Box 8801, Dayton, OH, 45401-8801, US

(21) Appl. No.: 10/486,216

(22) PCT Filed: Mar. 24, 2003
(86) PCT No.: PCT/JP03/03553

(30) Foreign Application Priority Data
Oct. 29, 2002 (JP) 2002-314838

(51) Int. Cl. G06F 13/00

(52) U.S. Cl. 710/301; 710/104; 710/113

(57) ABSTRACT

A device controller is used for controlling PCI devices or card devices on an add-inboard. To install multiple devices including a master device on the add-in board, and to build a multifunction PCI device or card device by smoothly controlling their operation, a device controller (1) is provided with a bus arbiter circuit (17) for handling bus mastering request from devices (D1-D8). The device controller causes the bus arbiter circuit (17) and a target detect circuit (16) to detect an initiator and a target, and a bus sequencer (2) to control signal issuing operation in a bus mastering cycle, for example, by an appropriate procedure based on the result of the detecting operation. An add-in board (30) is recognized as a single multifunction device.

This application is the national phase of international application PCT/JP03/03553 filed on Mar. 3, 2003 which designated the U.S., and that international application was not published under PCT Article 21(2) in English.

### TECHNICAL FIELD

The present invention relates to a device controller for controlling a Peripheral Component Interconnect (PCI) device or a card device on an add-in board.

### BACKGROUND ART

A method generally used when extending functional capabilities of a PCI bus or a card bus is to plug in an add-in board on which a device having necessary functions is mounted into a slot, for example. This method has a drawback, however, in that add-in boards that can be added are limited by the number of slots provided in a host device. Particularly because the number of PCI slots and card bus slots provided on the host device, such as a personal computer, tends to be reduced recently, an alternative method has sometimes been used for achieving the aforementioned extension of the functional capabilities. This method has been to install a bridge like a PCI-PCI bridge on an add-in board to configure hierarchized buses so that a plurality of PCI devices, for example, can be connected to secondary buses.

This approach has a problem, however, in that a large amount of circuitry is needed when a hierarchized bus structure is produced by adding a bridge like the PCI-PCI bridge on the add-in board. Another problem of this approach is that there is the need for software for controlling the bridge installed on the add-in board to ensure proper functioning of the add-in board.

Among conventional techniques directed to the solution of this problem is the use of a PCI bridge device which reduces the amount of circuitry while complying with the PCI standards, as described in Japanese Laid-open Patent Publication No. H11-288400, for example.

It has so far been said that it becomes possible with this kind of PCI bridge device to build a multifunction add-in board while achieving a reduction in the amount of circuitry as the PCI bridge device properly relays signals between primary and secondary sides.

In the conventional techniques including the one described in Japanese Laid-open Patent Publication No. H11-288400, the only subject that is controllable by a PCI bridge device is a target device. Therefore, when a master device is connected to the secondary side of the PCI bridge device and this master device works as an initiator, for instance, there would arise a problem that an operational error could occur. This means that it has not been possible with prior art technology to realize a multifunction capability when the master device (initiator) is mounted on the PCI bridge device.

Furthermore, as the PCI bridge device needs to acquire configuration information from individual devices on the secondary side and store that information in the PCI bridge device, there has been a problem that it is necessary to provide a separate storage unit in the bridge for storing all information on a configuration space including unused field information of the devices (e.g., base address space and interrupt pins), for instance.

It is an object of the present invention to provide a device controller which makes it possible to build a multifunction PCI device or card device by installing a plurality of general-purpose devices including a master device while achieving as much a reduction as possible in the amount of circuitry and by smoothly controlling the operation of these general-purpose devices.

### DISCLOSURE OF THE INVENTION

(1) A device controller of the invention includes a communications control unit for controlling communications between a host device and multiple devices having their own functions which are provided on an add-in board connected to a PCI slot or a card bus slot of the host device, a storage unit for storing a relationship between the individual functions of the multiple devices and multiple functions allocated to the add-in board, a determination circuit for determining which one of the devices is the device which should become the destination of access in a configuration access based on the relationship stored in the storage unit when the configuration access is made from the host device to the add-in board, and a header information supply circuit for substituting information conforming to the operation of the add-in board for information not conforming to the operation of the add-in board among information on the configuration space headers in a configuration space of the device specified by the determination circuit as the destination of the configuration access and then supplying the substituted information to the host device.

In this construction, when multiple devices (general-purpose LSIs) and the device controller of this invention are installed on the add-in board to allocate multiple functions to the add-in board connected to a PCI slot or a card bus slot, the aforementioned determination circuit determines the device which should become the destination of access in a configuration access based on information on such relationships that a device having the function of a network interface card corresponds to the first function of the aforementioned add-in board and a device having the function of a SCSI interface corresponds to the second function of the aforementioned add-in board, for instance, or the information stored in the aforementioned storage unit and, at the same time, the aforementioned header information supply circuit prevents such information that impedes correct functioning of the add-in board as a multifunction device from being supplied to the host device.

Therefore, the add-in board on which the device controller of this invention and the multiple devices are installed is recognized as a single multifunction device by the host device, and device information not conforming to the operation of the aforementioned add-in board is not supplied to the host device. Information concerning the configuration space which does not adversely affect the operation of the aforementioned add-in board is supplied from each of the aforementioned multiple devices to the host device, so that it becomes unnecessary for the aforementioned device controller to hold all information on each of the aforementioned multiple devices.

(2) The device controller of the invention further includes an arbiter circuit which, upon detecting that a bus mastering request has been issued from one of the devices provided on the add-in board, issues a bus mastering request in place of the device to the host device and authorizes the bus mastering request from the device upon receiving authorization of the bus mastering request from the host device, wherein the communications control unit detects a master device and a target device in a bus cycle of the host device and the device and performs communications between the host device and the device by a procedure based on the result of the detecting operation.

In this construction, the device controller is provided with the arbiter circuit for properly handling bus mastering requests from the aforementioned multiple devices. To achieve this, the arbiter circuit issues bus mastering requests to the host device in accordance with bus mastering requests successively issued from the aforementioned multiple devices and, upon receiving authorization of the bus mastering request from the aforementioned host device, authorizes bus mastering by each of the aforementioned multiple devices in an appropriate order, for example. It is therefore possible to properly handle the bus mastering request from the aforementioned master device even when the master device is included in the aforementioned multiple devices.

Furthermore, because the master device and the target device in a bus cycle of the aforementioned host device and the aforementioned device are detected by the aforementioned communications control unit and signal issuing operation in the aforementioned device controller is controlled by the appropriate procedure based on the result of this detection, smooth communications can be realized between the aforementioned host device and the aforementioned multiple devices.

### BRIEF DESCRIPTION OF THE DRAWINGS

FIG. 1 is a diagram showing the configuration of an add-in board to which the present invention is applied;

FIG. 2 is a diagram showing the configuration of a device controller according to the present embodiment;

FIG. 3 is a flowchart showing an operating sequence of the device controller according to the present embodiment;

FIG. 4 is a chart showing an example of device setup information; and

FIG. 5 is a chart showing common signals and dedicated signals of this embodiment.

### BEST MODES FOR CARRYING OUT THE INVENTION

Now, a PCI device controller according to an embodiment of the present invention is described in the following. While the device controller of the invention is used as a PCI device controller in this embodiment, the device controller of the invention can be used as a card device controller in the same manner.

Although PCI add-in boards offered as commercial products are in a state in which PCI devices suited to applications are readily mounted on-board, some users design PCI devices by themselves and produce PCI add-in boards suited to their own purpose of use by installing PCI devices (general-purpose LSIs) having desired functions on each PCI add-in board.

The PCI device controller (hereinafter referred to simply as the device controller) of this embodiment is of a type used by those users who produce PCI add-in boards by themselves as mentioned above or by PCI add-in board vendors. This device controller is characterized in that it enables a host device, such as a personal computer, to recognize the entirety of a PCI add-in board as a single multifunction PCI device having multiple functions when a plurality of PCI devices are installed on the PCI add-in board.

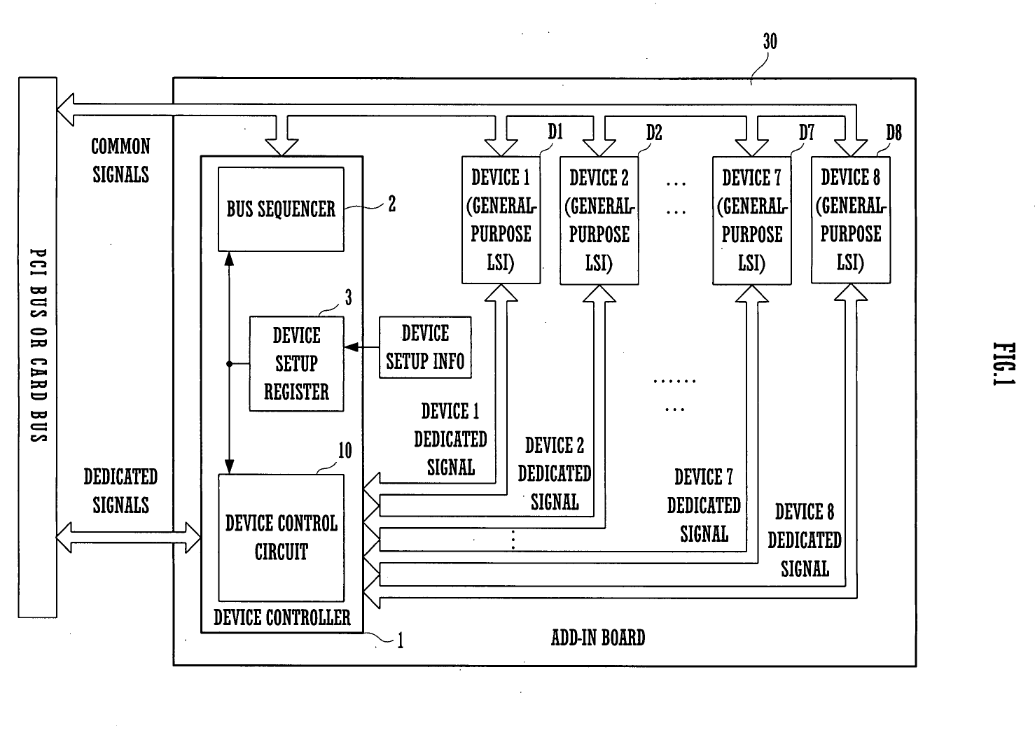

FIG. 1 shows the configuration of an add-in board on which the PCI device controller of this invention is installed. As shown in the Figure, the add-in board 30 carries general-purpose LSI devices (hereinafter referred to simply as the devices) D1-D8 each having a specific function useful for the operation of the host device, such as the function of a LAN card (network interface card) or the function of a SCSI interface, for example. The add-in board 30 also carries a later-described device controller 1 for controlling communications performed between the devices D1-D8 and a system bus of the host device via a PCI bus. Further, there are formed signal lines between the PCI bus and the devices D1-D8 or the device controller 1, and between the device controller 1 and the individual devices D1-D8, for transmitting specific signals.

Although the number of devices installed on the add-in board 30 is not limited to 8, there are not installed more than 8 PCI devices in this embodiment, because up to 8 functions are said to be definable with the PCI devices, in principle.

Normally, the devices D1-D8 complying with the PCI standards are each designed as a single-function device of which function is identified by function number 0 only, or as a multifunction device of which functions are identified by function numbers 0 to n (=7 at maximum).

Therefore, when the multiple PCI devices D1-D8 are directly connected to the add-in board 30, at least function number 0 is shared by the individual PCI devices so that it is not possible to determine which one of the devices D1-D8 is meant by information specifying function number 0 only. Consequently, there arises a problem that it is not possible to establish a proper configuration and the individual devices D1-D8 on the add-in board 30 do not operate correctly.

Among PCI devices, a master device which can work as an initiator is usually connected to a PCI slot in the host device by a point-to-point method. In a case where multiple master devices are installed on the add-in board 30, there exist more than one each of such signals as IDSEL, REQ#, etc. and it is impossible to properly control the individual signals. Therefore, there arises a problem that the add-in board 30 does not operate correctly as a as a multifunction board.

Here, IDSEL is a signal used for specifying an intended target device in a configuration cycle, REQ# is a signal that a master device transmits when requesting the right of use of the PCI bus, and GNT# is a signal that an arbitration function of a system transmits when authorizing the right of use of the PCI bus by the master device asserting REQ#.

Under such circumstances, there are installed a plurality of devices including a master device as well as the device controller 1 on the add-in board 30 in this embodiment, in which the device controller 1 serves to guarantee smooth communications between the host device and the devices D1-D8 on the add-in board 30 when the entire add-in board 30 forms a single multifunction PCI device.

Among the signal lines connecting the devices D1-D8 on the add-in board 30 to the host device, common signal lines are directly connected to the host device. The common signal lines are also connected the device controller 1. Therefore, common signals from the host device are directly input to the device controller and the devices D1-D8.

In contrast, dedicated signal lines are connected from the host device to the individual devices D1-D8 via the device controller 1. Thus, mode of communications used is such that dedicated signals output from the host device to the individual devices D1-D8 and from the individual devices D1-D8 to the host device are relayed by the device controller 1.

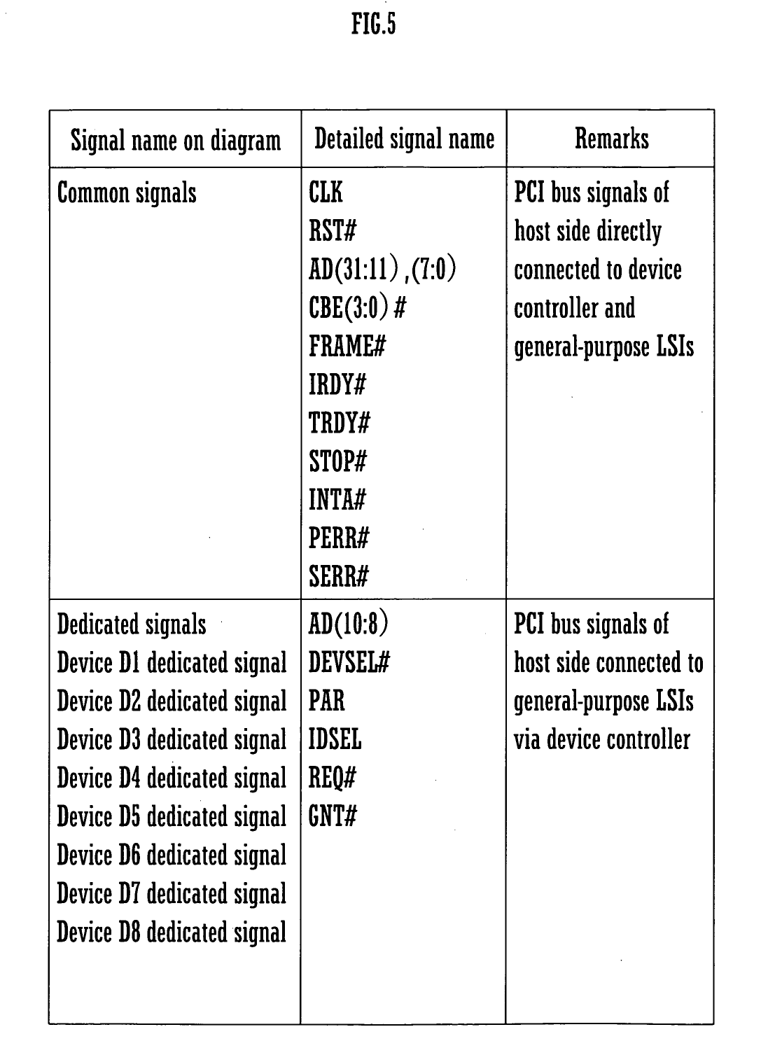

While the common signals include CLK, RST#, AD(31:11), AD(7:0), CBE(3:0)#, FRAME#, ITDY#, TRDY#, STOP#, INTA#, PERR# and SERR# as shown in FIG. 5, a detailed description of the individual signals is not provided here. The dedicated signals include AD(10:8), DEVSEL#, PAR, IDSEL, REQ# and GNT#.

The device controller 1 includes a bus sequencer 2, a device setup register 3 and a device control circuit 10. The bus sequencer 2 constituting a communications control unit of this invention is for realizing optimum sequence control operation in the add-in board 30 by issuing signals by an appropriate procedure according to ON/OFF states of input signals, for instance.

The device setup register 3 is for storing device setup information to be input for the individual devices D1-D8. Here, the device setup information is mainly information on functions (function information) of the devices D1-D8 connected to the device controller 1.

According to the PCI standards, add-in boards can be used by allocating 8 kinds of function numbers 0 to 7 per add-in board. When only function number 0 is used, for example, the add-in board 30 works as a single-function board, whereas when any of function numbers 1 to 7 is used besides function number 0, the add-in board 30 works as a multifunction board.

A designer of an add-in board can recognize the function numbers decoded in used devices from a data sheet, for example. If information on these function numbers are preset in the form of switch settings or in a nonvolatile memory, or if the individual functions provided on the add-in board 30 and the functions of the devices D1-D8 are memorized in a one-to-one correspondence with each other, the device controller 1 can recognize the functions of the devices D1-D8 as the functions of the add-in board 30.

In this embodiment, information on the relationship between the individual functions provided on the add-in board 30 and the functions of the devices D1-D8 is stored in the device setup register 3 as the device setup information. Here, the device setup register 3 constitutes a storage unit of this invention.

As shown in the foregoing discussion, the device controller 1 causes the host device to recognize the add-in board 30 as if it is a single multifunction device by converting the single function number of each device (general-purpose LSI) or the function numbers of the multifunction device.

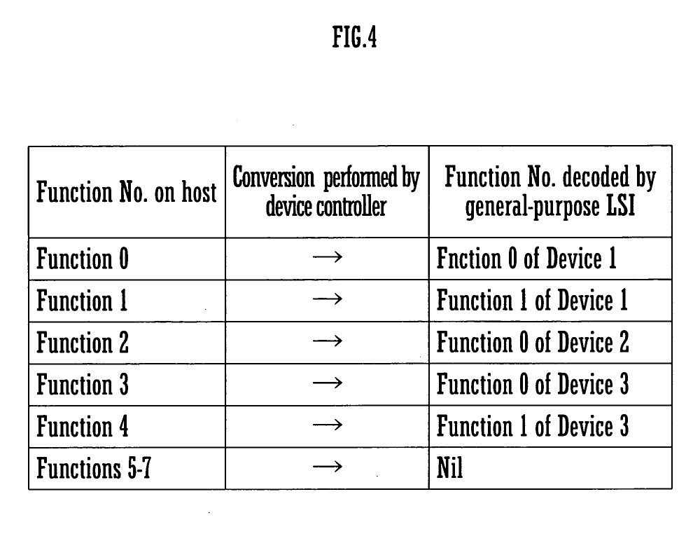

FIG. 4 shows an example of the device setup information. In the example of this Figure, the functions decoded in the device D1 are function numbers 0 and 1, the function decoded in the device D2 is function number 2, the functions decoded in the device D3 are function numbers 0 and 1, and the devices 4-8 are currently unconnected.

In this example, function 0 of the device D1 is recognized as function 0 of the add-in board 30 by the host device, function 1 of the device D1 is recognized as function 1 of the add-in board 30 by the host device, function 0 of the device D2 is recognized as function 2 of the add-in board 30 by the host device, and so on. It is understood from this that the individual functions provided on the add-in board 30 and the functions of the devices D1-D8 properly correspond to one another.

The device control circuit 10 in the device controller 1 is for realizing smooth communications between the host device and the multiple devices D1-D8 including the master device. Details of the device control circuit 10 will be later described.

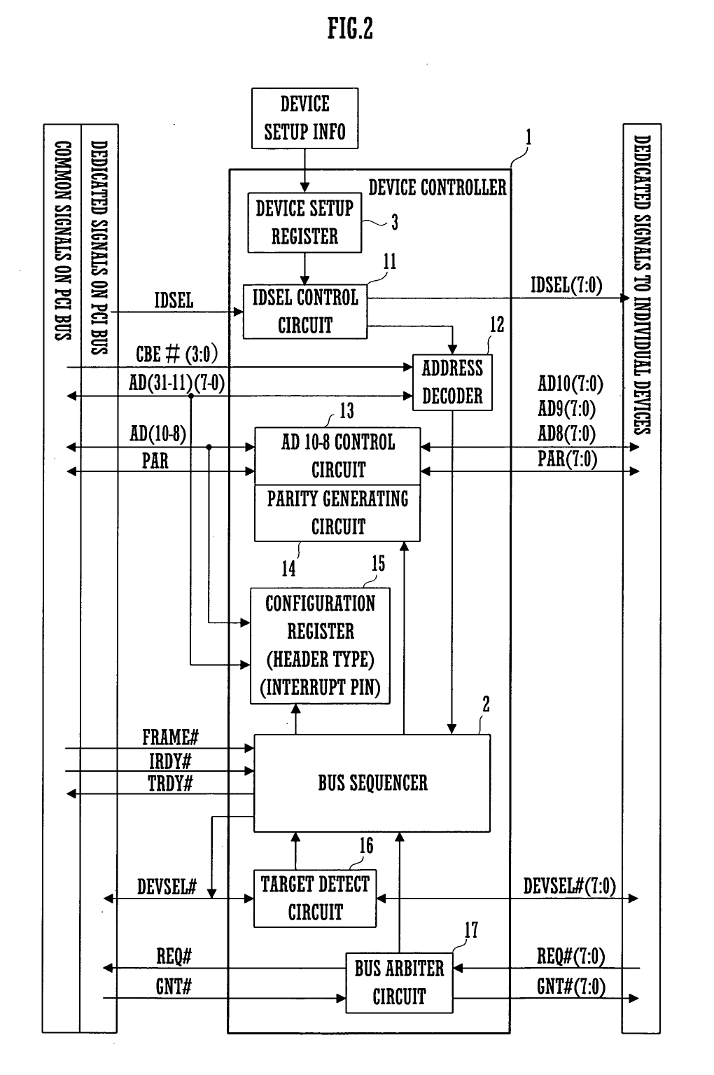

FIG. 2 is a diagram showing the configuration of the device controller 1 of this invention. As shown in this Figure, the device control circuit 10 includes an IDSEL control circuit 11, an address decoder 12, an AD 10-8 control circuit 13, a parity generating circuit 14, a configuration register 15, a target detect circuit 16 and a bus arbiter circuit 17.

The IDSEL control circuit 11 constitutes a determination circuit of this invention for determining which one of the devices D1-D8 is the destination of access in a configuration access made from the host device based on the information on the relationship between the individual functions provided on the add-in board 30 and the functions of the devices D1-D8 stored in the device setup register 3.

The address decoder 12 is provided with a circuit for selecting some specific lines from many interconnect lines in binary code, and for acquiring an address value. The address decoder 12 is mainly used for detecting which address of the configuration register owned by the devices D1-D8 the host device is going to access, for example.

The AD 10-8 control circuit 13 generates any desired function number using AD(10-8). The parity generating circuit 14 generates an even parity for detecting whether any problem has occurred in signals transmitted through AD(10-8) and CBE#(3:0) lines, that is, a total of 36 bits of data transmitted through 32-bit address data bus (AD) and command bus enable (CBE#) lines.

The configuration register 15 stores information on configuration space headers in a configuration space with respect to the devices D1-D8. In principle, the information on configuration space headers stored in the configuration register 15 matches information on the configuration space headers actually possessed by the devices D1-D8.

The device controller 1, however, prohibits the host device from directly reading the information on the configuration space headers in the configuration space with respect to the devices D1-D8 but causes the host device to read the information on the configuration space headers stored in the configuration register 15 instead of the information on the configuration space headers of the devices D1-D8. This is because it is necessary to make the host device recognize that the add-in board 30 is a multifunction device as a whole and that the add-in board 30 works while sharing an interrupt pin for multiple functions.

Specifically, the device controller 1 always causes the host device to recognize that the add-in board 30 is a multifunction board with respect to a header type register and the interrupt pin of the add-in board 30 and that an interrupt channel used is one channel INTA# regardless of the types of the devices D1-D8.

The target detect circuit 16 detects a target device from the input DEVSEL# signal. The bus arbiter circuit 17 is provided in consideration of the fact that a bus arbiter for resolving conflicts over the right of use of a bus is conventionally not provided on PCI device side but on motherboard side (slot side). The bus arbiter circuit 17 settles the conflicts over the right of use of the bus of the aforementioned master device by granting a bus mastering request from the master device included in the devices D1-D8, for example. The bus arbiter circuit 17 constitutes an arbiter circuit of this invention.

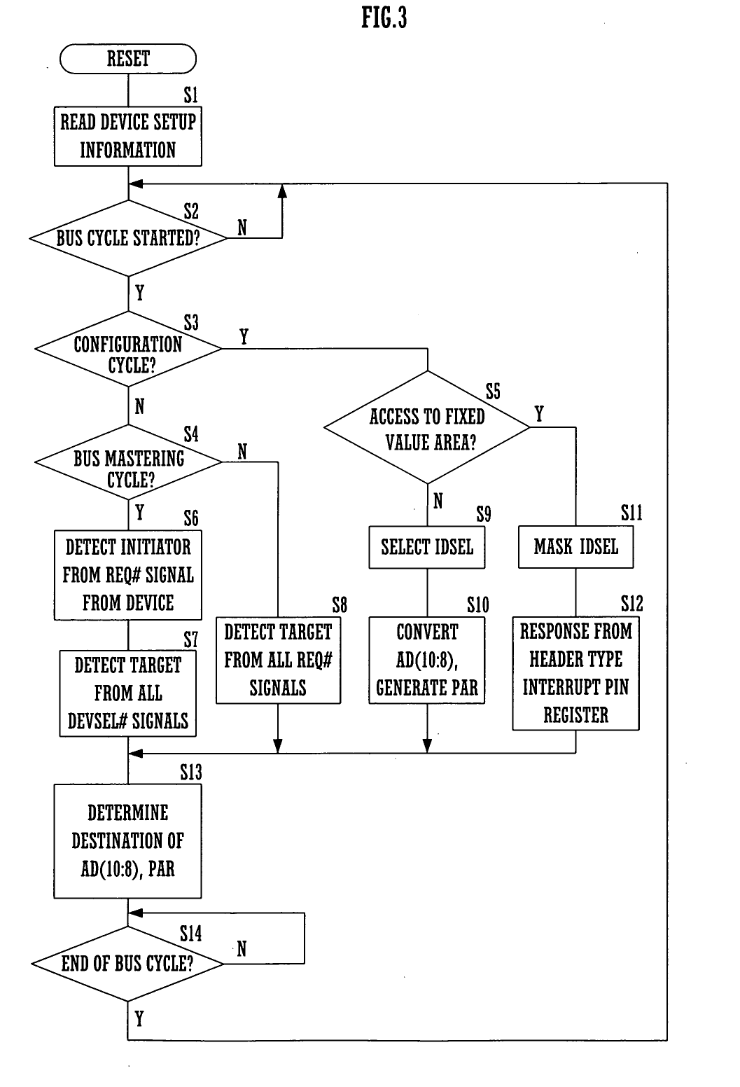

FIG. 3 is a flowchart showing an operating sequence of the device controller 1. In the aforementioned configuration of the device controller 1, the device controller 1 reads out the device setup information from DIP switch settings on the add-in board 30 and stores it in the device setup register 3 at the time of resetting (S1).

Next, the device controller 1 waits until a bus cycle begins as a result of a request for data transfer issued from any device to another (S2). Upon detecting the beginning of the bus cycle in wait process of S1, the device controller 1 judges whether the bus cycle is a configuration cycle (S3). It is to be noted that the configuration cycle is normally executed at startup of a personal computer.

If the bus cycle started is judged to be a configuration cycle in the judgment process of S3, the device controller 1 verifies whether the configuration cycle is an access to a fixed value area from the address decoder 12 (S5). Here, the fixed value area means an area in which information to be recognized by the host device for enabling the add-in board 30 to function as a multifunction device is stored, such as the header type register (80h=multifunction board) in the configuration space header or the interrupt pin (01h=INTA#) to be used. In other words, the fixed value area means an area in which fixed values to be indicated to the host device are stored regardless of the types of the connected devices D1-D8.

If the configuration cycle is judged to be an access to the fixed value area in the judgment process of S5, the device controller 1 masks IDSEL signals of the individual devices D1-D8 to prohibit any response to the individual devices D1-D8 (S11), and the bus sequencer 2 in the device controller 1 causes the host device to read out information stored in the fixed value area of the configuration register 15 instead of information stored in any of the fixed value areas of the devices D1-D8 which are destinations of the configuration access (S12).

This is because a contradiction occurs when the add-in board 30 works as a multifunction device if information indicating that it is a single-function device is stored in any of the fixed value areas of the devices D1-D8, for instance. It is also because an operational failure occurs if information indicating that multiple interrupt channels can be used in accessing the fixed value areas of the individual devices D1-D8 regardless of the fact that only one interrupt channel INTA# is provided for the common signals on the add-in board 30.

While four channels of PCI slots can be used as interrupt channels INTA#-INTD#, only one channel of card bus slot is usable as an interrupt channel. Thus, the invention employs a specification for sharing INTA# regardless of the number of the individual devices D1-D8 so that the device controller 1 can be used in any slot. The aforementioned steps of S11 and S12 correspond to the operation of a header information supply circuit of this invention for substituting information conforming to the operation of the aforementioned add-in board for information not conforming to the operation of the aforementioned add-in board among information on the configuration space headers in the configuration space of the device specified as the destination of a configuration access and supplying the substituted information to the aforementioned host device.

If the configuration cycle is judged to be an access to other than the fixed value area in the judgment process of S5, the device controller 1 selects one of the devices D1-D8 that is the destination of the configuration access by using the device setup information stored in the device setup register 3 and asserts IDSEL (S9). At this time, the AD 10-8 control circuit 13 performs data conversion to achieve integrity of data format with function numbers decoded by the aforementioned device. At the same time, the parity generating circuit 14 generates a new parity bit to achieve integrity of the parity bit (S10).

If the bus cycle started is not judged to be a configuration cycle in the judgment process of S3, on the other hand, the device controller 1 judges whether the bus cycle started is a bus mastering cycle (S4).

If the bus cycle started is judged to be a bus mastering cycle in the judgment process of S4, the device controller 1 specifies a bus master which should become the initiator of the aforementioned bus mastering cycle by causing the bus arbiter circuit 17 to detect a REQ# signal transmitted from the master device working as the initiator of the aforementioned bus mastering cycle (S6).

At this time, the host device asserts GNT# in response to the aforementioned REQ# signal. Since the bus arbiter circuit 17 maintains previously memorized information on the order of REQ# signals asserted by the devices D1-D8, the bus arbiter circuit 17 asserts a GNT# signal authorizing one of the devices D1-D8 to use the signal lines according to the memorized order. Here, there is created a state in which as if the device controller 1 has acquired DMA channel privilege on the master side.

When the bus arbiter circuit 17 detects the master device which has transmitted the bus mastering request, the bus sequencer 2 can detect the initiator of the aforementioned bus mastering cycle. On the other hand, the target detect circuit 16 monitors whether a DEVSEL# signal indicating that the bus cycle has been recognized is returned from any one of the devices D1-D8 which can become a target in the aforementioned bus mastering cycle. The target detect circuit 16 detects one asserted terminal in this fashion and specifies the target device (S7).

This means that it is made possible for the device controller 1 to determine whether a command or data should be transferred to the host device or to one of the devices D1-D8, or data should be held within the device controller 1 itself by monitoring all DEVSEL# signals in the aforementioned manner.

If DEVSEL# from the host device is asserted, it is possible to determine that the target device in the aforementioned bus mastering cycle exists on the bus of the host device, for example. In contrast, DEVSEL# from the device D2 is asserted, the target exists in the device D2.

Since the bus sequencer 2 can detect locations of the master device which works as the initiator and the target device under the aforementioned conditions, the AD 10-8 control circuit 13 and the parity generating circuit 14 which perform data transfer are caused to issue signals by a proper procedure based on the detected locations of the master device and the target device (S13).

If the bus cycle started is not judged to be a bus mastering cycle in the judgment process of S4, the device controller 1 detects the master device from all DEVSEL# signals (S8), and causes the bus sequencer 2 to control the operation of the AD 10-8 control circuit 13 and the parity generating circuit 14 for issuing signals using a procedure based on the result of the aforementioned detecting process (S13).

This means that if the bus cycle started is judged to be other than the bus mastering cycle, the initiator exists on the bus of the host device to perform configuration read/write, memory read/write, I/O read/write, special cycle, reserve and other cycles.

As it is predetermined that the initiator exists on the bus of the host device in this case, it is possible to detect the target device in the aforementioned bus cycle by the target detect circuit 16. As it becomes possible for the bus sequencer 2 under these conditions to control the direction of data transfer from the initiator, the AD 10-8 control circuit 13 and the parity generating circuit 14 in the aforementioned bus cycle, the bus sequencer 2 can cause the AD 10-8 control circuit 13 and the parity generating circuit 14 which perform data transfer to issue signals by the proper procedure (S13).

Then, after the beginning of the bus cycle, the device controller 1 causes the bus sequencer 2 to detect conditions of the end of the bus cycle in operation of each bus cycle regardless of its type (S14). After the bus sequencer 2 has detected the end of the bus cycle in step S14, the device controller 1 waits for the beginning of another bus cycle (S14→S2).

As thus far described, it becomes possible to install the multiple devices D1-D8 on the add-in board 30 and cause the host device to correctly recognize the whole add-in board 30 as a single multifunction device by using the device controller 1 of the present invention. Conventionally, devices to be used for achieving a multifunction capability with PCI devices have been limited to target devices, so that there has been a problem that data transfer has been possible in the PIO transfer method only. However, it becomes possible, in particular, to realize the multifunction capability with multiple PCI devices including the master device by using the device controller 1 of the present invention, so that it is possible to use not only the PIO transfer method but also the bus master transfer method as means for transferring data at a high transfer rate.

Additionally, since the multifunction capability of the PCI devices can be realized by using the device controller 1 of this invention without producing a hierarchized bus structure, it is possible to reduce wait time which used to occur in a conventional bus hierarchization circuit.

When simultaneous bus mastering requests are made from the individual devices D1-D8, the devices D1-D8 which are granted access to the bus may be determined by setting an order of priority based on a fixed priority or cyclic priority scheme by the device control circuit 10. The fixed priority scheme has an advantage that the cache hit rate is improved because the same device tends to be used successively. The cyclic priority scheme has an advantage that all the devices are given a generally equal opportunity to access the bus.

While the device controller of this invention is used to build a multifunction PCI device in the present embodiment, the device controller of the invention can also be used to build a multifunction card device.

It is to be noted that although IDSEL signal lines are not used due to their own characteristics in card bus specifications in which a single slot is allocated to a single bus number unlike in PCI specifications in which multiple slots are allocated to a single bus number, it is possible to ensure proper functioning of the multifunction card device built up by the device controller of this invention as the device controller of the invention pulls up the IDSEL signal lines and asserts IDSEL in a simulated fashion.

As so far discussed, when multiple devices (general-purpose LSIs) and the device controller of this invention are installed on the add-in board to allocate multiple functions to the add-in board connected to a PCI slot or a card bus slot, the aforementioned determination circuit determines the device which should become the destination of access in a configuration access based on the information on the relationship between the individual functions of the aforementioned add-in board and the aforementioned multiple devices stored in the aforementioned storage unit and, at the same time, the aforementioned header information supply circuit supplies information necessary for the add-in board to function as a multifunction device to the host device in this invention. This makes it possible to cause the host device to correctly recognize the add-in board on which the device controller of this invention and the multiple devices are installed as a single multifunction device and to prevent device information not conforming to the operation of the aforementioned add-in board from being supplied to the host device.

It is also possible to make it unnecessary for the aforementioned device controller to hold information on the configuration space of each of the aforementioned multiple devices.

Furthermore, as there is provided the arbiter circuit in the device controller for handling bus mastering requests from the aforementioned multiple devices, it is possible to properly handle the bus mastering request from the master device even when the aforementioned master device is included in the aforementioned multiple devices.

Since the aforementioned communications control unit detects the master device and the target device in the bus cycle from the aforementioned host device and the aforementioned devices and controls signal issuing operation in the aforementioned device controller by the procedure based on the result of this detection, it is possible to realize smooth communications between the aforementioned host device and the aforementioned multiple devices.

### INDUSTRIAL APPLICABILITY

The present invention is suited for use for configuring a multifunction PCI device or card device by installing a plurality of devices including a master device on an add-in board while achieving as much a reduction as possible in the amount of circuitry and by smoothly controlling the operation of those devices.

1. A device controller comprising:
a communications control unit for controlling communications between a host device and multiple devices having their own functions which are provided on an add-in board connected to a PCI slot or a card bus slot of the host device;
a storage unit for storing a relationship between the individual functions of the multiple devices and multiple functions allocated to the add-in board;
a determination circuit for determining which one of the devices is the device which should become the destination of access in a configuration access based on the relationship stored in the storage unit when the configuration access is made from the host device to the add-in board; and
a header information supply circuit for substituting information conforming to the operation of the add-in board for information not conforming to the operation of the add-in board among information on the configuration space headers in a configuration space of the device specified by the determination circuit as the destination of the configuration access and then supplying the substituted information to the host device.

2. The device controller according to claim 1 further comprising:
an arbiter circuit which, upon detecting that a bus mastering request has been issued from one of the devices provided on the add-in board, issues a bus mastering request in place of the device to the host device and authorizes the bus mastering request from the device upon receiving authorization of the bus mastering request from the host device;
wherein the communications control unit detects a master device and a target device in a bus cycle of the host device and the device and performs communications between the host device and the device by a procedure based on the result of the detecting operation.
